(19) United States
(12) Patent Application Publication
(10) Pub. No.: US 2016/0217442 A1
(43) Pub. Date: Jul. 28, 2016

(54) Method for Payment

(71) Applicant: GIESECKE & DEVRIENT GMBH, München (DE)

(72) Inventors: Martin AUER, Pfeffenhausen (DE); Thomas MILLER, Puchheim (DE); Claus GRÜNDEL, München (DE); Wolfgang DECKER, Grünwald (DE)

(21) Appl. No.: 15/023,802

(22) PCT Filed: Sep. 22, 2014
(86) PCT No.: PCT/EP2014/002566

§ 371 Date: Mar. 22, 2016

(30) Foreign Application Priority Data
Sep. 27, 2013 (DE) 10 2013 016 119.3

(51) Int. Cl. G06Q 20/12; G06Q 20/32; G06Q 30/06; G06Q 20/38

(52) U.S. Cl. CPC G06Q 20/12; G06Q 20/3825; G06Q 20/3227; G06Q 30/0619; G06Q 2220/00

(57) ABSTRACT

A method, for trade between a buyer and a seller using a sales server of the seller and a terminal device of the buyer, for allowing a payment in accordance with a transaction data record from the buyer to the seller, wherein a) the payment request is provided by the sales server for a terminal service server, and b) the terminal service server uses the transaction data record for the terminal device to produce a one-time terminal. The payment is prompted, wherein c) the one-time terminal is transmitted, d) the one-time terminal is put into contact with a payment transaction security element, e) the payment information is extracted in cryptographically protected form and transferred to the one-time terminal, f) the transferred payment information is transmitted to the terminal service server or to the sales server, and g) the transmitted payment information is used to prompt the payment.

The invention relates to a method to enable a buyer to effect payment to a seller in accordance with a transaction data set, and a method for executing the payment. The method is provided for trade between a buyer and a seller by means of a sale server of the seller and an end device of the buyer, to enable payment from the buyer to the seller in accordance with a transaction data set. The actual initiation of the payment is effected e.g. with a payment transaction card or, more generally, a payment transaction security element. The method is suitable both for the online trade and for the stationary trade.

In online trading, a seller operates a sale server. A buyer uses an end device, e.g. a computer or a mobile telephone, to buy goods or services from the online shop, thus from the sale server, of the seller. The buyer has various payment options for effecting payment, in dependence on the payment options offered by the respective online shop.

The basic structure of payment is as follows. By the sale server, a payment request is output which comprises a transaction data set with at least the amount of money to be paid and the currency of the amount of money. The payment request is transmitted to the end device and made available to the buyer on the end device. In response to the payment request, the buyer sends a payment information item to the sale server by means of his end device. Utilizing the payment information item, the payment from the buyer to the seller in accordance with a data set is initiated, for example via bank servers of the banks of the buyer and the seller. As payment data there are provided, depending on the type of payment transaction card, e.g. card data of a credit card (as a rule credit card number, expiry date, card validation code) or bank account data for e.g. a direct debit procedure or wallet data from an electronic wallet (also referred to as e-wallet).

In stationary trade, e.g. in a store of a seller, the seller operates a sale server and a stationary payment terminal with a card reader for payment transaction cards. The payment terminal is for example placed at the checkout desk. Some stores offer self-payment terminals as an alternative to the checkout, said self-payment terminals likewise having a payment terminal with card reader. The sale server as a rule remains in the background for the buyer, since the selection of e.g. goods is effected on the basis of the actual goods. As soon as the buyer has concluded his selection of goods, he goes to the payment terminal and states that he wishes to pay. As a reaction, the seller outputs a payment request to the buyer at the payment terminal, e.g. by displaying an amount of money to be paid on a display. In response to the payment request, the buyer has his payment transaction card read out by the card reader, thereby providing the payment terminal with payment information. The payment terminal forwards the payment information to the sale server, which finally forwards it to bank servers for processing the payment (settlement and clearing).

Examples for payment transaction security elements are physical payment transaction cards, for example credit cards, debit cards or electronic wallets. As alternatives to physical payment transaction cards, virtual payment transaction cards are known, which are provided in the mobile telephone or in a mobile telephony security element (e.g. (U)SIM, UICC, eUICC) of the mobile telephone. Also a virtual payment transaction card can be configured optionally as a virtual credit card, virtual debit card or virtual wallet (also referred to as e-wallet or simply wallet). Examples for e-wallets are GoogleWallet or Apple Passbook.

Particularly in the online trade, conventional payment methods have disadvantages.

When payment is effected in the online trade by bank transfer or direct debiting, the buyer necessarily discloses his identity to the seller, which is possibly not desired by the buyer. Additionally, between the initiation of the transfer or the direct debiting by the buyer and the receipt of the money by the seller, a period of several days can pass. Some sellers dispatch the goods only after receipt of the payment, such that the buyer has to wait for the goods for a long time.

In the online trade, conventional credit card payment is faster than a bank transfer or direct debiting. Here, an input mask of the online shop is shown on the buyer's end device, where the buyer must input credit card data of his credit card manually in plain text. For this purpose, the buyer must read and copy the visually specified credit card data from the card. Since all card data are transferred in plain text, there is the risk of the seller misusing the credit card data.

For the seller, a disadvantage of conventional credit card payment with manual inputting of the credit card data is that it cannot be ensured upon the manual inputting that the credit card is actually present. Accordingly, this is a so-called card-not-present payment. Credit card organizations charge a higher settlement fee for card-not-present payments than for so-called card-present payments. In a card-present payment, it is ensured that the credit card is present. This is achieved e.g. by using a credit card with a chip and reading out the credit card number from the chip card with a chip card reader.

If the buyer has a payment transaction card with a chip and a card reader connected or connectible to his end device, he can execute a card-present payment also in the online trade.

In secured credit card payment on the Internet, the buyer is redirected by the online shop of the seller to a temporarily displayed website of the credit card organization as soon as he has input his credit card data. On this website, the customer must answer security questions. If the buyer answers the security questions correctly, a payment confirmation is output, the website of the credit card organization is no longer displayed and the buyer is redirected back to the online shop. On the server level, in this method a temporary connection is established by the sale server to the credit card server. However, the credit card server is not directly involved in the acceptance of credit card data from the buyer. In contrast, the inputting of the credit card data is effected in the conventional fashion, possibly in the card-not-present mode.

Cloud payment services such as e.g. PayPal or Yapital , enable instant payment for the buyer in the online trade, without the buyer having to pass sensitive payment information such as e.g. credit card data to the seller. The cloud payment service provider acts as an intermediary between the buyer and the seller via his own cloud payment database, without disclosing confidential payment information of the buyer to the seller. In contrast, the buyer must make payment information available to the cloud payment service provider.

From the perspective of the buyer, a fast and secure payment method would be desirable, in which he can maintain anonymity. This is (only) partially made possible by Paypal and similar cloud payment services. For the seller, a card-present payment method would be advantageous.

The object of the invention is to create a card-present payment method for the trade between a buyer and a seller, said method enabling the buyer to maintain anonymity, and being secure and fast. The method is to be suitable for the online trade and the stationary trade.

The object is achieved by a method for enabling payment according to claim 1. Claim 10 specifies a method for initiating the execution of a thus enabled payment. Advantageous embodiments of the invention are specified in dependent claims.

The method for enabling payment according to claim 1, according to the preamble, presumes a trade between a buyer and a seller by means of a sale server of the seller and an end device of the buyer. Further according to the preamble, the payment in question comprises an outputting of a payment request with a transaction data set by the sale server, and an initiation of the payment in accordance with a transaction data set by making available a payment information item. These criteria are fulfilled for example by a conventional credit card payment in the online trade, with the credit card data as payment information.

The method according to claim 1 is characterized in that

a) the payment request is made available by the sale server to a terminal service server, and
b) on the terminal service server, using the transaction data set, a one-time terminal is generated for the end device that can be made available on the end device, wherein the one-time terminal is so configured that as soon as it is made available on the end device, it is connectible on the end device with a payment transaction security element containing the payment information, such that the payment information is extracted in cryptographically secured form from the payment transaction security element and made available to the one-time terminal.

By the payment information being gathered from the payment transaction security element, e.g. a credit card, by means of the one-time terminal, a card-present transaction is given, for which the seller has to pay only a decreased transaction fee. Functionally, the one-time terminal is comparable to a stationary payment terminal of a store and serves to retrieve payment information from a payment transaction security element (e.g. payment transaction card). The one-time terminal according to the invention is configured as software, e.g. an application, that can be run on the end device. This has the advantage that the one-time terminal can be transmitted to the buyer via substantially any desired contactless or contact-type or contactless/contact-type in combination communication connection. As software, the one-time terminal can be installed substantially on any desired end device. Thereby the buyer does not need to go to a remote stationary terminal, the terminal comes to the buyer instead. Of course the buyer can use the one-time terminal also when he is in a store and a stationary payment terminal is available as an alternative.

By the payment request not being sent directly to the buyer, but to the buyer via the detour of the terminal service server, the buyer can prevent having to disclose his identity to the seller. The buyer consequently has the option to remain anonymous. This applies to both stationary and online trade.

By the payment information being output in cryptographically secured form from the payment transaction security element and being transmitted to other entities (e.g. servers) only in this cryptographically secured form, no conclusion as to the buyer can be drawn from the transmitted payment information either. Thereby the method is secure and anonymous for the buyer.

The method further permits instant payment, without a time delay which occurs e.g. in (advance) bank transfers or direct debiting.

Optionally, as end device of the buyer, a mobile telephone, smart phone or tablet PC is provided. The buyer can use such an end device both remotely (e.g. from his home) in online trade and in a stationary store in order to execute the way of payment according to the invention.

Therefore, according to claim 1, a card-present payment method is made possible for the trade between a buyer and a seller, which permits to the buyer to pay in secure fashion, fast, even instantly, and to maintain anonymity while so doing, and which can be utilized equally in online trade and in stationary trade.

Optionally, the transaction data set contains obligatorily an amount and a currency. Optionally, the transaction data set further contains one or several of the following additional information items: a seller identifier, by means of which the seller can be identified (e.g. one or several of: name, company, abbreviation, possibly address); an invoice identifier, e.g. an invoice number; a purpose of use.

Optionally, as payment transaction security element a payment transaction card with a contactless or/and a contact-type interface is provided. When the payment transaction security element is brought into a communication connection with the one-time terminal, the payment transaction card is brought into a communication connection with the end device via the interface. The end device has an end device interface corresponding to the interface of the payment transaction card.

As interface of the payment transaction security element/ the payment transaction card, there is provided e.g. an NFC interface or WLAN interface or a Bluetooth interface or an audio plug or a contact-type chip card interface (e.g. ISO/IEC 7816-3, Apple Lightning, USB, Mini/Micro USB, SD, Micro-SD, FireWire, GSM 11.11, GPRS, UMTS).

Optionally, as payment transaction security element a payment transaction software is provided that is implemented in the end device, in particular a virtual payment transaction card having an end device-internal interface to the one-time terminal of the end device.

Optionally, the end device contains a removable or permanently implemented mobile telephony security element, e.g. a SIM card, UICC or eUICC.

Optionally, the payment transaction security element is provided as a payment transaction software in the mobile telephony security element. In this embodiment, the connection between the one-time terminal and the payment transaction security element comprises a first, external connection between the one-time terminal and the mobile telephony security element and a second, internal connection disposed within the mobile telephony security element to the payment transaction security element.

Optionally, any one of the following is provided as payment information: credit card data, comprising at least a credit card number (and most frequently additionally an expiry date of the credit card and a card validation code from the back side of the credit card), to enable payment by credit card; bank account data (e.g. account number, bank code number, etc.; or IBAN, BIC, etc.) to enable direct debiting; wallet data to enable payment from an electronic wallet.

Optionally, the payment information is cryptographically secured by encryption or/and provided with a cryptographic signature for cryptographic securing. Alternatively, a cryptographically secured transmission channel is ensured between the payment transaction security element and the bank server which finally processes the payment. The bank server has the required confidential information (e.g. a decryption key), in order to read the payment information and to execute the payment.

Optionally, further an end device identifier specific to the end device is made available to the sale server. Optionally, further in a) the end device identifier is made available by the sale server to the terminal service server and in b) the one-time terminal is generated using the end device identifier. In particular, the “use” of the end device identifier optionally comprises measures in order to ensure that the generated one-time terminal is subsequently transmitted to the correct end device. Optionally, the mobile telephone number of the end device is contained in the one-time terminal or is added to the one-time terminal upon generation of the one-time terminal. It is thereby ensured that the one-time terminal is transmitted to the correct end device without any further action. Optionally, the end device identifier is additionally or alternatively used to generate a one-time terminal that is adapted to or personalized for the specific end device. By the adaptation/ personalization for example device-specific properties are taken into account upon generation of the one-time terminal.

Optionally, the end device identifier is configured such that the terminal service server can identify the end device by means of the end device identifier, whereas the sale server cannot do so.

Optionally, for this purpose the end device identifier is made available by the end device in cryptographically secured, in particular encrypted form. The sale server does not have any cryptographic means, in particular decryption keys, in order to make the end device identifier allocatable to the end device. In contrast, the terminal service server has such cryptographic means, in particular decryption keys.

Optionally, in order for only the terminal service server to be able to allocate the end device identifier to the end device, the end device identifier is determined as desired, in particular randomly, without reference to true identity data of the end device or an owner of the end device. Only the terminal service provider knows the allocation between the end device identifier and true identity data of the end device or an owner of the end device.

The end device identifier is optionally agreed in a prior registration procedure between the terminal service server and the end device or between the terminal service provider and the owner of the end device. In the registration procedure the owner registers first with his end device at the terminal service provider using his true identification data, for example at least the mobile telephone number of the end device. The anonymous end device identifier is derived on the basis of the true identification data. For communication processes outside of the terminal service server, the anonymous end device identifier is used exclusively, but never the true identification data, in particular not the mobile telephone number.

The registration procedure including the agreement of the end device identifier is effected optionally on the occasion of downloading a framework application to the end device, which will be described further below.

According to the invention, further a method is specified for initiating payment, which has been enabled as described above. The method for initiating is further characterized in that

c) the one-time terminal previously generated in accordance with a), b) is transmitted by the terminal service server to the end device and is made available on the end device of the buyer,
d) the one-time terminal is brought into a communication connection with a payment transaction security element containing the payment information,
e) the payment information is extracted in cryptographically secured form from the payment transaction security element and transferred to the one-time terminal in the end device,
f) the transferred payment information is transmitted by the one-time terminal in the end device to the terminal service server or to the sale server,
g) with the transferred payment information the payment from the buyer to the seller is initiated in accordance with the transaction data set while using the payment information.

In step f) the payment information can be transmitted optionally to the terminal service server or to the sale server. From there, the payment information is finally forwarded to a bank server in order to actually execute the payment. Since the payment information is cryptographically secured, in particular also the route via the sale server is admissible. The cryptographic securing can be implemented optionally, as described further above, by encrypting the payment information or/and operation of a cryptographically secured transmission channel from the payment transaction security element up to the bank server.

Optionally, prior to a) the end device sends a payment-mode message to the sale server, by which it is determined that the payment is to be carried out via the terminal service in accordance with the invention. By determining the mode of payment, the execution of step a) is initiated. Optionally, the buyer sends a payment-mode message from his end device to the sale server. In stationary trade, optionally the seller can scan or photograph a QR code (quick response code) displayed on the end device or provided by the buyer in a different form, thereby initiating the execution of step a). QR codes have become widespread in the meantime, in order to so represent network addresses of remote servers that a scanning or photographing of the QR code is sufficient to establish a network connection to the server.

Optionally, further, if an end device identifier is used, the end device identifier is sent to the sale server together with or in the payment-mode message. Thereby the end device enables the sale server to subsequently send a payment request personalized to the end device, without the sale server being taught the true identity of the end device.

According to a first embodiment, the one-time terminal can be provided as an independent application on the end device. According to a second embodiment of the invention, the one-time terminal is provided as a component application inserted in a framework application.

According to the second embodiment, optionally the framework application is implemented on the end device in a preparatory step. In the payment method of the invention then

in c) the one-time terminal is transmitted to the framework application of the end device and made available by the framework application on the end device of the buyer or/and
in d) the one-time terminal is connected to the payment transaction security element via the framework application or/and
in e) the payment information is extracted from the payment transaction security element by means of the framework application and transferred to the one-time terminal in the end device or/and
in f) the transferred payment information is transmitted by the one-time terminal in the end device to the terminal service server by means of the framework application.

The framework application is for example downloaded to the end device from an app store known per se.

Optionally, further, in order to finally actually execute the payment method, h) the payment information is transmitted to the bank server, in particular either directly to a bank server or to the bank server via the seller's server, and i) the payment is executed on the bank server in accordance with the transaction data set. (Settlement and clearing for the payment process on the bank server.)

In particular, the payment information can be sent to the bank server via the sale server without hesitation due to its cryptographic securing (e.g. encryption or/and cryptographically secured channel from the end device to the bank server). The anonymity of the buyer vis-à-vis the seller is maintained.

Optionally, at any suitable stage of the method, a notification is sent to the sale server about the initiation or/and the execution of the payment. The notification about the initiation or/and the execution of the payment is effected optionally in particular in the case that in f) the transferred payment information is sent by the one-time terminal in the end device to the terminal service server and finally to the bank server, while omitting the sale server.

In the following the invention will be explained in more detail on the basis of exemplary embodiments and with reference to the drawing, in which there are shown:

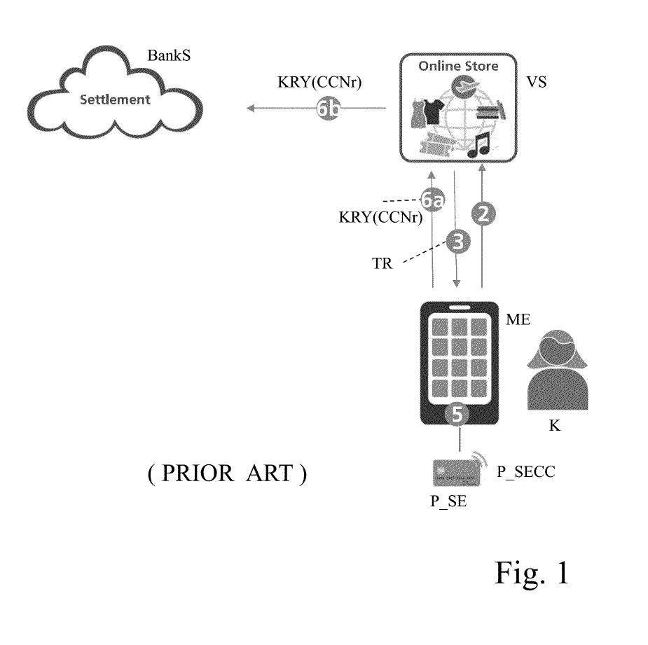

FIG. 1 a diagram illustrating a credit card payment in the online trade, according to the state of the art;

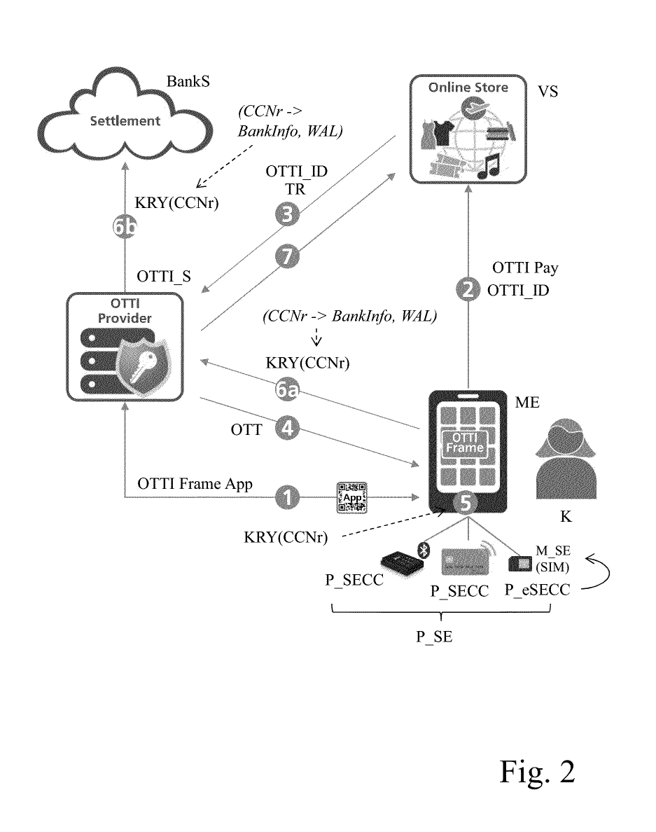

FIG. 2 a diagram illustrating a payment method in the online trade, according to an embodiment of the invention.

FIG. 1 shows a diagram illustrating a credit card payment in the online trade, according to the state of the art. A buyer K has a mobile end device ME (mobile entity) with a web browser. The buyer K accesses the website of an online shop with the mobile end device ME. The web site of the online shop is technically realized on a sale server VS.

Subsequently, the method of shopping and paying by credit card between the sale server VS of the seller and the end device ME of the buyer K will be explained. The numbering of the method steps corresponds to the method according to the invention described further below, wherein comparable steps are designated by the same step number in FIG. 1 and FIG. 2. The numbering in FIG. 1 is therefore not continuous. In a step 2 a buyer K buys goods (or/and services) using his mobile end device ME from an online store of the seller by placing them in the virtual shopping cart. The buyer K goes to the checkout virtually and selects credit card P_SECC as payment mode (P=payment, i.e. payment transaction; SE=secure element, i.e. security element; CC=credit card). In a step 3 the sale server VS sends a payment request to the end device ME. The payment request is displayed visually as an input mask on a display of the end device ME. In a step 5 the buyer K reads the credit card number CCNr from his credit card P_SECC as payment information and types it into the input mask via a keyboard (possibly also implemented on the touch screen) of his end device ME. By operating a button “confirm” or the like, the input credit card number CCNr is sent to the sale server VS in a step 6a. In a step 6b the credit card number CCNr is further sent to a bank server BankS, which finally executes the payment (in banking terminology: settlement and clearing of the payment process).

FIG. 2 shows a diagram illustrating the payment method OTTI Pay of the invention. In the method of FIG. 2, like in the method of FIG. 1, there are involved a sale server VS of an online shop, an end device ME of a buyer and a bank server BankS of a bank. Further, in the method a credit card P_SECC is involved, here more exactly, according to an embodiment of the invention, an NFC-capable credit card (NFC=near field communication). Alternatively, a virtual credit card P_eSE (e=embedded, i.e. virtual, in the form of software) is provided that is implemented in the SIM card SIM (subscriber identity module) of the end device ME. According to a further embodiment, a virtual credit card P_eSECC (e=embedded) implemented in the end device ME itself is provided. In contrast to the method of FIG. 1, in the method of FIG. 2 further additionally a terminal service OTTI Provider (OTTI=one-time terminal identification; with OTT=one-time terminal, corresponding to OTP for one-time password) is involved, which operates a terminal service server OTTI_S. The terminal service OTTI Provider offers a framework application OTTI Frame App for download by mobile end devices in a publicly accessible app store. The downloaded framework application OTTI Frame App later enables the buyer to have one-time terminals OTT generated by the terminal service OTTI Provider sent to his end device.

Subsequently, the payment method according to FIG. 2 will be described. In a preparatory step 1 the buyer registers with the OTTI Provider for the OTTI Pay payment method and downloads the framework application OTTI Frame App to his mobile end device ME from the app store. For the OTTI Frame App to be downloadable, the buyer K must first specify the mobile telephone number of his end device ME. On the occasion of downloading/ installing the framework application OTTI Frame App between the terminal service server OTTI_S and the end device ME, an end device identifier OTTI ID is agreed, by means of which the terminal service server OTTI _S can identify the end device ME in the future. Otherwise, the end device ME remains anonymous also vis-à-vis the terminal service OTTI Provider.

The process of shopping initially starts in the method of FIG. 2 as described with reference to FIG. 1. In a step 2 the buyer places goods in the shopping cart and goes to the virtual checkout of the online shop. Upon selecting the payment mode, the buyer K now selects “OTTI Pay” according to the invention, and sends the selection to the sale server in a payment-mode message. The payment-mode message further contains in particular the end device identifier OTTI ID previously agreed between the end device ME and the terminal service OTTI Provider. In a step 3 the sale server VS sends a payment request together with the end device identifier OTTI ID to the terminal service server OTTI_S.

Using the end device identifier OTTI ID, the terminal service server OTTI _S generates a one-time terminal OTT for the end device ME. The “use” of the end device identifier OTTI ID in the generation of the one-time terminal OTT is optionally limited to subsequently sending the generated one-time terminal OTT to the end device designated by the end device identifier OTTI ID. If required, the end device identifier OTTI ID is additionally used in order to take account of device-specific properties while generating the one-time terminal OTT and to generate a one-time terminal OTT that is specifically adapted to the end device ME. In a step 4 the terminal service server OTTI_S sends the generated one-time terminal OTT to the end device ME designated by the end device identifier OTTI ID. The one-time terminal OTT is received by the framework application OTTI Frame App on the end device. The framework application OTTI Frame App initiates that on a display of the end device ME subsequently a request is output to the buyer K (user of the end device ME), to place his NFC-capable credit card P_SECC within NFC-reach of his end device ME. The buyer K places the credit card P_SECC within NFC-reach of his end device ME. In a step 5 the encrypted credit card number CCNr is read out from the credit card P_SECC in a cryptogram KRY as payment information and transmitted via NFC to the NFC interface of the end device ME. In the end device ME the cryptogram KRY with the encrypted credit card number CCNr is transferred to the framework application OTTI Frame App. In a step 6a, the framework application OTTI Frame sends the cryptogram KRY with the encrypted credit card number CCNr to the terminal service server OTTI_S. In an (optional) step 7 the sale server VS is informed by the terminal service server OTTI _S that the buyer K has authorized the payment in binding fashion. Step 7 can be effected before or after step 6b or uncoupled from the execution of step 6b. In a step 6b the terminal service server OTTI_S forwards the cryptogram KRY with the encrypted credit card number CCNr to a bank server BankS at the bank that is in charge of settling the account of the credit card P_SECC of the buyer K. The bank or the bank server BankS finally executes the payment.

If in the method according to FIG. 2 a virtual payment card (e.g. credit card) implemented in the end device ME or in a mobile telephony security element M_SE, e.g. SIM card, of the end device ME, is provided as payment transaction security element P_SE instead of an external NFC credit card, the method is effected optionally as described above. Alternatively, as soon as the one-time terminal OTT has been received on the end device ME by the framework application OTTI Frame App, it is provided that the framework application OTTI Frame App contacts the payment transaction security element P_SE (e.g. P_eSECC or virtual card in the SIM) without interaction of the buyer K and retrieves the payment information (e.g. CCNr) via an end device-internal interface and sends it to the terminal service server OTTI_S.

According to an alternative, the steps 6a and 6b are executed such that the cryptogram with the payment information/credit card number CCNr is sent to the sale server VS (instead of to the terminal service server OTTI_S). The sale server VS sends the cryptogram KRY with the credit card number CCNr to the bank server BankS, which finally executes, i.e. processes (settlement and clearing), the payment as described above.

1-13. (canceled)

14. A method for enabling, in trade between a buyer and a seller by means of a sale server of the seller and an end device of the buyer, a payment from the buyer to the seller in accordance with a transaction data set,
wherein upon payment, the method comprising:
outputting a payment request comprising the transaction data set by the sale server; and
initiating the payment in accordance with the transaction data set by making available a payment information item;
wherein in the method further comprises:
a) making the payment request available by the sale server to a terminal service server; and
b) making on the terminal service server a one-time terminal available on the end device generated by using the transaction data set for the end device, wherein the one-time terminal is configured such that,
as soon as it is made available on the end device, it is connectible on the end device to a payment transaction security element containing the payment information, such that the payment information is extracted in cryptographically secured form from the payment transaction security element and made available to the one-time terminal.

15. The method according to claim 14, wherein the transaction data set obligatorily contains an amount and a currency and optionally further one or several of the following additional information items: seller identifier, invoice identifier, purpose of use.

16. The method according to claim 14, wherein as payment transaction security element a payment transaction card is provided with a contactless or/and contact-type interface, wherein, when the payment transaction security element is brought into communication connection with the one-time terminal, the payment transaction card is brought into communication connection with the end device via the interface.

17. The method according to claim 14, wherein as payment transaction security element a payment transaction software implemented in the end device, a virtual payment transaction card, is provided, which has an end device-internal interface to the one-time terminal of the end device.

18. The method according to claim 14, wherein the end device contains a removable or permanently implemented mobile telephony security element, wherein the payment transaction security element is provided as payment transaction software in the mobile telephony security element.

19. The method according to claim 14, wherein as payment information any one of the following is provided: credit card data, comprising at least a credit card number, for enabling payment by credit card; bank account data to enable direct debiting;
wallet data to enable payment from an electronic wallet.

20. The method according to claim 14, wherein the payment information is cryptographically secured by encryption or/and provided with a cryptographic signature for cryptographic securing.

21. The method according to claim 14, wherein further an end device identifier specific to the end device is made available to the sale server, and wherein further
in a) the end device identifier is made available by the sale server to the terminal service server and
in b) the one-time terminal is generated using the end device identifier.

22. The method according to claim 21, wherein the end device identifier is configured such that the terminal service server can identify the end device by means of the end device identifier, whereas the sale server cannot do so.

23. A method for initiating a payment enabled according to claim 14, wherein
c) the one-time terminal is transmitted by the terminal service server to the end device and is made available on the end device of the buyer,
d) the one-time terminal is brought into communication connection with a payment transaction security element containing the payment information,
e) the payment information is extracted in cryptographically secured form from the payment transaction security element and transferred to the one-time terminal in the end device,
f) the transferred payment information is transmitted by the one-time terminal in the end device to the terminal service server or to the sale server, and
g) with the transmitted payment information the payment from the buyer to the seller is initiated in accordance with the transaction data set, using the payment information.

24. The method according to claim 23, wherein prior to a) the end device sends a payment-mode message to the sale server, by which a payment mode via the terminal service is determined, wherein further, by determining the payment mode, the execution of step a) is initiated, and wherein the end device identifier is sent to the sale server together with or in the payment-mode message.

25. The method according to claim 23, wherein in a preparatory step a framework application is implemented on the end device, wherein
in c) the one-time terminal is transmitted to the framework application of the end device and is made available by the framework application on the end device of the buyer or/and
in d) the one-time terminal is connected to the payment transaction security element via the framework application, or/and
in e) the payment information is extracted by means of the framework application from the payment transaction security element and transferred to the one-time terminal in the end device, or/and
in f) the transferred payment information is transmitted by means of the framework application by the one-time terminal in the end device to the terminal service server.

26. The method according to claim 14, wherein further
h) the payment information is transmitted to the bank server, in particular transmitted either directly to a bank server or transmitted to the bank server via the seller's server and
i) on the bank server the payment is executed in accordance with the transaction data set.
